(19) United States
(12) Patent Application Publication
(10) Pub. No.: US 2015/0355620 A1
(43) Pub. Date: Dec. 10, 2015

(54) MANAGEMENT SYSTEM FOR PROCESS RECIPE

(71) Applicant: KINSUS INTERCONNECT TECHNOLOGY CORP., Taoyuan (TW)

(72) Inventor: Shu-Jen Hsiao, Hsinchu City (TW)

(21) Appl. No.: 14/296,422

(22) Filed: Jun. 4, 2014

(51) Int. Cl. G05B 19/05

(52) U.S. Cl. CPC G05B 19/054; G05B 2219/1157

(57) ABSTRACT

A management system includes a product specification data base for storing a plurality of product numbers and product specifications corresponding to the product numbers respectively; a parameter-setting data base for storing principles of parameter-settings; a device specification data base for storing application rules for a plurality of process devices; an execution processor coupled to the product specification data base, the parameter-setting data base and the device specification data base for processing based on the product specification data base, the parameter-setting data base and the device specification data base to produce process recipes of products corresponding to the specification numbers and converting into a plurality of process files adapted to be applied by corresponding process devices; and a process recipe data base coupled to the execution processor for storing the plurality of process files.

### BACKGROUND OF THE INVENTION

1. Field of the Invention

The present invention relates generally to a management system, and more particularly to a management system for managing a process device or a product and parameter-settings for the process device or the product via cloud computing so as to establish a standardization.

2. The Prior Arts

Referring to FIG. 1, which shows a diagram of a traditional process device 100 of the prior art, a factory includes a plurality of traditional process devices 100, each is provided with a controller 120 consisting of a control interface 121 and a process data base 123, wherein a plurality of process recipes corresponding to a plurality of products are stored within the data base 123. Upon requirement, a respective process recipe is fetched from the data base 123 manually by an operator.

The conventional fetching method suffers the following disadvantages: (I) manually fetching of process recipe results in higher error; (II) for a particular process device, since that particular process device is not updated, no consistency of process recipe is resulted and thus the fetching cannot be established as a standardization; (III) because the backup data of the process recipe are setup manually by the operator concerned, in case of the concerned operator leaves the present occupation, there may result in incomplete data.

As such, it is urgently required to establish a complete management system that is adapted to be controlled automatically in a standardization form.

### SUMMARY OF THE INVENTION

A primary objective of the present invention is to provide a management system for managing a process device or a product, and includes a product specification data base, a parameter-setting data base, a device specification data base, an execution processor and a process recipe data base. The product specification data base stores a plurality of product numbers and product specifications corresponding to the product numbers respectively. The parameter-setting data base stores principles of parameter-settings. The device specification data base stores application rules for a plurality of process devices. The process recipe data base stores a plurality of process files.

The execution processor is coupled to the product specification data base, the parameter-setting data base, the device specification data base and the process recipe data base for processing based on the product specification data base, the parameter-setting data base, the device specification data base and the process recipe data base to produce process recipes of products corresponding to the specification numbers and converting into a plurality of process files adapted to be applied by corresponding process devices.

Preferably, the execution processor is coupled via wire or wirelessly to an operation input interface of one corresponding process device such that once a product number is inputted into the interface, the execution processor fetches a respective one of the process files from the process recipe data base and transmits the respective one of the process files to the interface so as to permit operation of the corresponding process device according to the respective one of the process files.

The specific characteristic of the present management system resides in that since a standardization form can be established, minor error is resulted and the management system is not affected owing to leaving of a concerned operator and inconsistent data since the leaving operator cannot take the process data along with him.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a diagram of a traditional device of the prior art; and

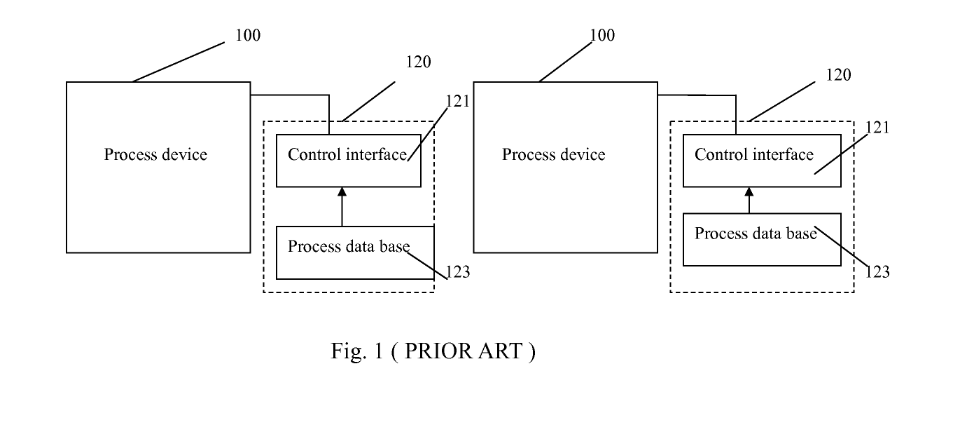

FIG. 2 shows the components constituting a management system of the present invention for managing process recipe.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

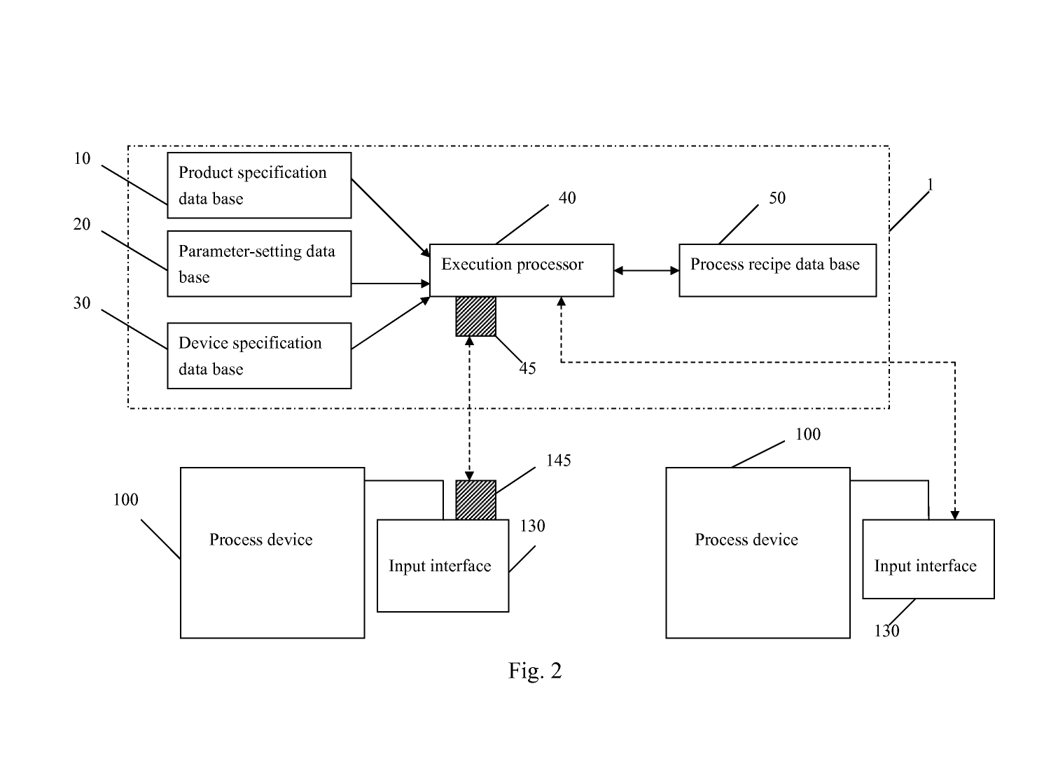

FIG. 2 shows the components constituting a process recipe management system of the present invention for managing process recipe. As illustrated, the process recipe management system 1 includes a product specification data base 10, a parameter-setting data base 20, a device specification data base 30, an execution processor 40 and a process recipe data base 50. The product specification data base 10 stores a plurality of product numbers and product specifications corresponding to the product numbers respectively, such as thickness of electroplated articles. The parameter-setting data base 20 stores principles of parameter-settings, the principles such as etching times and temperatures of the article during etching process. The device specification data base 30 stores application rules for a plurality of process devices 100, such as operation times, temperature, upper and lower limits, process files. In actual application, each of the product specification data base 10, the parameter-setting data base 20, the device specification data base 30 and the process recipe data base 50 is in form of a memory device, a disk storage or a disk array.

The execution processor 40 is coupled to the product specification data base 10, the parameter-setting data base 20, the device specification data base 30 and the process recipe data base 50 for processing based on the product specification data base 10, the parameter-setting data base 20, and the device specification data base 30 to produce process recipes of products corresponding to the specification numbers and converting into a plurality of process files adapted to be applied by corresponding process devices. The process recipe data base 50 is coupled to the execution processor for storing the plurality of process files therein.

In this embodiment, the execution processor 40 is coupled via wire or wirelessly to an operation input interface 130 of one corresponding process device 100 such that once a product number is inputted into the interface 130, the execution processor 40 fetches a respective one of the process files from the process recipe data base 50 and transmits the respective one of the process files to the interface 130 so as to permit operation of the corresponding process device 100 according to the respective one of the process files. Preferably, the execution processor 40 is selected from a group consisting of a computer and a server.

More preferably, the input interface 130 is selected from a group consisting of a computer, a Programmable Logic Controller (PLC), a barcode scanner, and a reader of a RFID tag. The execution processor 40 is further provided with an encryption unit 45 while the input interface 130 is provided with a decoding unit 145 for encrypting and decoding data during a data transmission so that the transmitted data cannot be stolen.

The specific characteristic of the present management system resides in that since a standardization form can be established, little error of the process is resulted and the management system can be adjusted by those participants so as to improve the process recipe and the management system is not affected owing to leaving of a concerned operator. In addition, inconsistency of data and loss of data can be avoided when using the management system of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A process recipe management system comprising:
a product specification data base for storing a plurality of product numbers and product specifications corresponding to said product numbers respectively;
a parameter-setting data base for storing principles of parameter-settings;
a device specification data base for storing application rules for a plurality of process devices;
an execution processor coupled to said product specification data base, said parameter-setting data base and said device specification data base for processing based on said product specification data base, said parameter-setting data base and said device specification data base to produce process recipes of products corresponding to said specification numbers and converting into a plurality of process files adapted to be applied by corresponding process devices; and
a process recipe data base coupled to said execution processor for storing said plurality of process files;
wherein, said execution processor is coupled via wire or wirelessly to an operation input interface of one corresponding process device such that once a product number is inputted into said interface, said execution processor fetches a respective one of said process files from said process recipe data base and transmitting the respective one of said process files to said interface so as to permit operation of said corresponding process device according to the respective one of said process files.

2. The management system according to claim 1, wherein said input interface is selected from a group consisting of a computer, a Programmable Logic Controller (PLC), a barcode scanner, and a reader of a RFID tag.

3. The management system according to claim 1, wherein said execution processor is provided with an encryption unit, said input interface being provided with a decoding unit for encrypting and decoding data during a data transmission.

4. The management system according to claim 1, wherein said execution processor is communicated via wire or wirelessly to said operation input interface of said corresponding process device.

5. The management system according to claim 1, wherein said execution processor is selected from a group consisting of a computer and a server.

6. The management system according to claim 1, wherein each of said product specification data base, said parameter-setting data base, said device specification data base and said a process recipe data base is in form of a memory device, a disk storage, or a disk array.
